(19) United States
(12) Patent Application Publication
(10) Pub. No.: US 2024/0191316 A1
(43) Pub. Date: Jun. 13, 2024

(54) Pyrometallurgical Method for Recycling Shredded Material of Waste from the Production of New and Defective or End-of-Life Batteries for Electric Vehicles or Portable Li-Ion Batteries

(71) Applicant: ECO'RING, Chambéon (FR)

(72) Inventor: Jean-Luc Roth, Metz (FR)

(21) Appl. No.: 18/552,339

(22) PCT Filed: Mar. 25, 2022
(86) PCT No.: PCT/FR2022/050565

§ 371 Date: Feb. 23, 2024

(30) Foreign Application Priority Data
Mar. 26, 2021 (FR) FR2103117
Jun. 24, 2021 (FR) FR2106738

(51) Int. Cl. C21C 5/56; C21B 13/00; C21B 13/08; C21C 5/36; C21C 7/00; C22B 1/243

(52) U.S. Cl. CPC C21C 5/562; C21B 13/0013; C21B 13/0066; C21B 13/085; C21C 5/36; C21C 7/0025; C22B 1/243

(57) ABSTRACT

A pyrometallurgical process for recycling shredded spent electric vehicle batteries of Li-ion type and/or waste from the production of these new batteries and battery rejects, and/or portable batteries of Li-ion type. The process entails the addition of iron, smelting via the supply of energy, separation of a slag, oxidizing treatment and separation of a second slag.

### TECHNICAL FIELD

Portable or electric vehicle batteries of Li-ion type comprise valuable elements and it is important that they should be properly recycled: Copper Cu, Aluminium Al (2 metals contained in metallic form), Nickel Ni, Cobalt Co, Manganese Mn and evidently Lithium—the latter in the form of combined oxides.

In most known channels, the recycling of these batteries—whether rejects or waste from new battery production, spent batteries or faulty new batteries—include a shredding step in a shredder which separates Copper and Aluminium (metals) in good proportion and produces a «black mass» grouping together the other metals as well as a high proportion of carbon, in elemental form (C-Fix) or in combined form, in plastics and oils similar to hydrocarbons.

It is specified that the production of new batteries produces waste such as cuttings from anode or cathode rolls, anode and cathode rejects, faulty assemblies of anodes and cathodes called bundles, faulty assemblies of anodes and cathodes placed in pouches without solvent called dry cells and faulty pouches with solvents. As an example, a synopsis is given of the waste resulting from the production of new batteries.

Several solutions are currently proposed and being tested to recover this black mass, most often via hydrometallurgical process—and in several steps.

In this document there is proposed a three-step pyrometallurgical recovery solution:
Agglomeration of the black mass (pelleting, briquetting, or extrusion)—with the addition of iron ore or oxidized or non-oxidized scrap iron, the general notion of the iron source is given herein—and a suitable binder.
Carburizing smelting in a rotary converter (or other type of converter equipped with an agitation device) allowing separation of Lithium in a slag and dust comprising lithium oxide Li2O, that is decanted and is readily usable in current industries producing this metal.
Oxidizing refining in the same converter or in a second specific converter, leading to an alloy of FeNiCo type containing about 50% (Ni+Co), which can be used to produce high-strength steels (in particular steels used in aeronautics), and to a slag with high Manganese, Iron and lime content which forms an excellent raw material for furnaces producing Ferro-Manganese.

### TABLE OF CONTENTS

1. Problem to be solved
1.1 Composition of electric vehicle batteries
1.2 Industrial recovery—Objective of the proposed process
1.3 Prior art
1.4 Principle of the proposed process
2. Example
2.1. Composition of the «Black Mass+Fe ore» mix
2.2. Mass balances
2.2.1. Smelting
2.2.2. Refining
2.3. Upcycling applications
2.4. The case of low-Phosphorus Black Mas
3. Summary

### 1. PROBLEM TO BE SOLVED

### 1.1 Composition of Electric Vehicle Batteries

Electric vehicle batteries are of 2 types:
Batteries of NiMH type (Nickel Metal Hydrides)
Batteries of Li-ion type

It is this latter type which currently tends to prevail. The possibility and efficiency of the recycling of Li-ion batteries amount to a major challenge in the development of electric vehicles or of portable applications (cells phones, laptops, electric bikes . . . etc.).

The recycling of Li-ion batteries gives rise to major new changes by the manufacturers of these batteries and many alliances have recently been set up for this purpose.

In the remainder hereof there is proposed a solution that associates shredding with a pyrometallurgical process for the compete recycling of these Li-ion batteries.

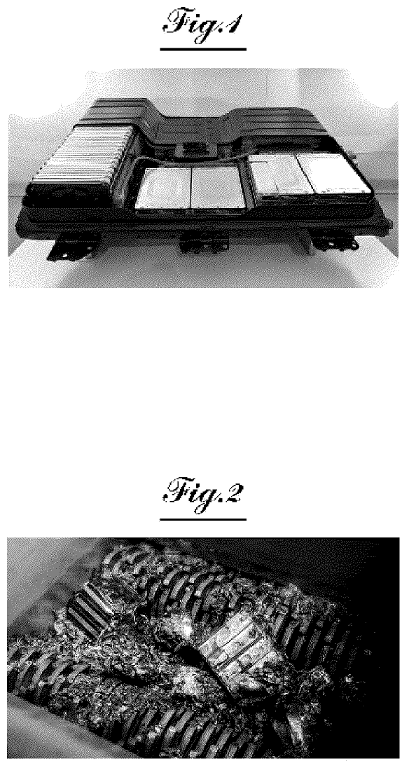

The principle and exact composition of these Li-ion batteries is widely described elsewhere, and it is sufficient to recall the scale of these batteries which can weigh from a few grams (button type) up to several hundred kilograms as suggested in FIG. 1 above, and the overall composition thereof given in Table 1.

### [FIG. 1]: Overall View of an Electric Vehicle Battery

TABLE 1
Composition-Li-ion battery type

| | quantity (wt. %) according |
|---|---|
| | to a reference in the |
| Component | literature |
| Cathode, anode and electrolyte | 39.1 +/− 1.1 |
| Plastic casing | 22.9 +/− 0.7 |
| Steel casing | 10.5 +/− 1.1 |
| Copper foil | 8.9 +/− 0.3 |
| Aluminium foil | 6.1 +/− 0.6 |
| Polymer foil and electrolyte | 5.2 +/− 0.4 |
| Solvent (non-aqueous) | 4.7 +/− 0.2 |
| Electric contacts | 2.0 +/− 0.5 |

The active core of the battery (cathode/anode/electrolyte) is chiefly composed of oxides and/or phosphates of LiNiO2, LiCoO2, LiMnO2, LiFePO4 type, of graphite and fluoride LiPF6 for the electrolyte, dissolved in an organic solvent.

More specifically, the production of new batteries is accompanied by the production of several levels of waste or rejects, such as cuttings from anode and cathode rolls, anode and cathode rejects, faulty assemblies of anodes and cathodes called bundles, faulty assemblies of anode and cathodes packaged in pouches without solvent called dry cells and faulty pouches with solvents.

For example, Table 2 below gives a synopsis of this waste production during the manufacture of new batteries, at different stages.

The valuable elements tat it is crucial to properly recycle on account of environmental- and energy-related costs are Copper Cu, Aluminium Al (two metals contained in metallic form), Nickel Ni, Cobalt Co, Manganese Mn and evidently Lithium.

The potentially important presence is noted of Phosphorus P, a steel pollutant, and of Fluoride F a source of corrosion of the constituent refractories and steels of the processing plant.

### 1.2 Industrial Recovery—Objective of the Proposed Process

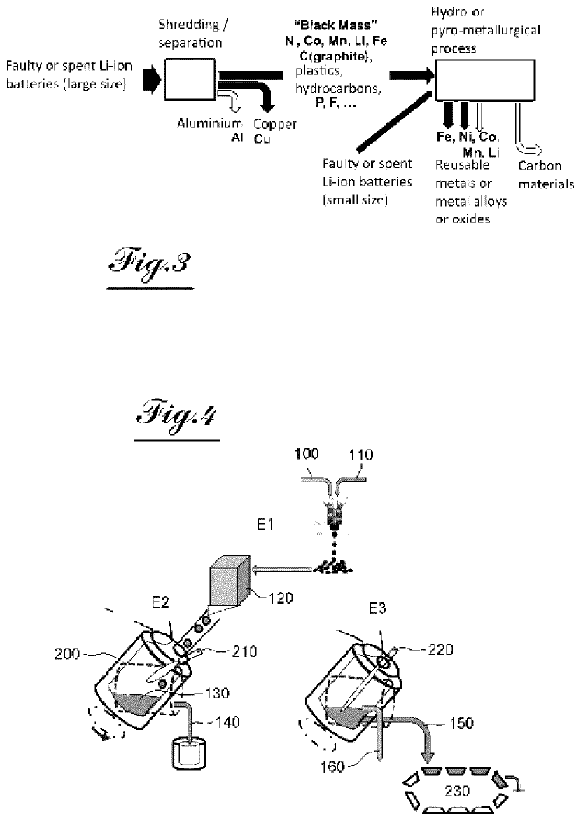

The recycling of large-size Li-ion batteries mostly includes complete shredding (FIG. 2)

### [FIG. 2] Li-Ion Batteries in the Grip of a Shredder.

This shredding and the separation tooling following thereafter allow the efficient separation of the metals contained in metallic form—Al, Cu and Fe (steel). The remainder is shred and/or recovered in the form of a mass of sludge composed of fines measuring less than 2 mm and an organic liquid, the mass being called «black mass».

The objective of complete recycling is to recover all the valuable elements in forms that are usable. This objective can be reached with different types of processes—hydrometallurgical or pyrometallurgical. The entire sector is schematized in FIG. 3 below.

### [FIG. 3] Global Li-Ion Battery Recycling Industry

### 1.3 Prior Art

At the current time, it would seem that most companies or groups which have launched into the recycling of Li-ion batteries experiment with or are focusing on a scheme such as illustrated in FIG. 3, with shredding and recovery of the black mas using hydrometallurgical processes.

An example of an analysis of a black mass is given in Table 3 below.

### Black Mass Analysis (Dry Weight %)

TABLE 3

| | % | | % | | % |
|---|---|---|---|---|---|
| Ni | 17.0 | Co | 7.0 | S | 0.20 |
| Li | 4.4 | Mn | 10.0 | P | 0.50 |
| Fe | 1.0 | Cu | 0.40 | Ca | 0.02 |
| Al | 0.80 | Cfix | 28.0 | HC | 12.0 |

It is to be noted that:
This analysis represents a «mix» of batteries from various sources and therefore containing various active compounds, and in particular a large share of batteries having active components containing Phosphorus P (e.g. LiFePO4);
If the starting material is spent batteries of one same type free of Phosphorus or with low P content, in particular if batches of P-free faulty new batteries are recycled in a plant, there will be little or no P content;
There subsist non-negligible residual contents of Copper Cu and Aluminium Al, contained in metallic form, and therefore incompletely removed at the shredding step and consecutive separation step;
The high content of Phosphorus must be removed as much as possible from the metal to be recovered.

A comparison will not be made here between the proposed industrial processes, but it can simply be said in this case that hydrometallurgical processes in theory suffer from severe handicaps compared with a pyrometallurgical process:
they require a large number of steps (at least as many as the metals to be separated);
they consume large amounts of chemical reagents that are hazardous for man and the environment and also costly;
they lead to higher quantities of end waste (polluted acid solutions) to be neutralized and placed in storage.

The above provided that a pyrometallurgical solution is able to reach the objective of extracting all the valuable metals in a form that can be reused.

### 1.4 Principle of the Proposed Process

There is therefore proposed a process for recovering the black mass derived from lithium batteries, the process comprising the addition of iron ore or oxidized or non-oxidized scrap iron to the black mass to obtain a mixture, smelting the mixture under the supply of energy to obtain a carburized metal bath, separating a first slag to obtain a purified metal bath, followed by oxidizing treatment of the purified metal bath and separation of a second slag, to obtain a ferroalloy.

The ferroalloy obtained is high Nickel and Cobalt content, the metals to be recovered for the manufacture of high-strength steels. The first slag is high in lithium in oxide form Li2O, and the second slag is high is manganese and lime when lime is added at the oxidizing step, in particular to extract Phosphorus P from the ferroalloy. It is advantageous to separate the two slags independently of each other to allow separate recovery of the lithium and manganese. They are separated by pour-off after decanting, the first before the oxidizing treatment step, and the second after the oxidizing treatment. The presence of iron ore or scrap iron, which is another source of iron, allows the operation to be conducted at lower temperatures and minimizes loss of nickel and cobalt in the form of oxides. In general, and as is the case in the analysis of black mass given as an example, this mass contains sufficient Carbon to ensure reducing of the oxides and carburizing of the metal obtained, up to 3-4% C in the carburized ferroalloy. If this is not the case, carbon is added in the form of anthracite or a substitution carbon material for smelting of the mixture. This ensures that smelting is definitely carburizing i.e. reducing, so that the reducible metals namely cobalt, iron and nickel, but also copper and manganese are effectively reduced.

Advantageously, agglomeration into pellets or briquettes or by extrusion is carried out before smelting. This allows bulk storage and transport via conveyor to the converter, and avoids airborne losses of material when loading.

Advantageously, smelting is carried out in a rotary converter or a converter equipped with an agitation device This allows the mixture to be homogenized while it is being smelted.

Advantageously the addition of iron ore at about 94% iron oxide Fe2O3 in a proportion of ½ quantity of iron ore per 1 quantity of battery black mass is added to the battery black mass to obtain the mixture to be smelted. Depending on the composition of the black mass, this proportion can be varied to target an amount of iron in the ferroalloy close to 50% by weight.

Advantageously, the black mass is derived from shredded or disassembled lithium batteries.

Advantageously, slaked lime is added as binder to facilitate agglomeration at least of the black mass and iron ore or scrap iron.

Advantageously, quicklime which may or may not be pure is added at the oxidizing treatment.

Advantageously, a continuous production operation is launched during which an addition of carbon is made to one fraction of the metal bath resulting from oxidizing treatment after separation of the second slag, this fraction being used to receive new feeds of black mass and iron ore or scrap iron thereby forming the mixture that is the subject of smelting leading to the obtaining of the carburized metal bath.

The proposed process comprises 3 steps:
agglomeration of the black mass (pelleting, briquetting, or extrusion)—with a suitable binder and iron ore or scrap iron, whether or not oxidized;
carburizing-reducing smelting in a rotary converter (Top Blown Rotary Converter—TBRC), or optionally a fixed converter with other means of bath agitation, in particular via injection of a gas (hydrocarbon or hydrogen) into the bottom of the reactor;
oxidizing refining in the same converter, or in a second specific converter.

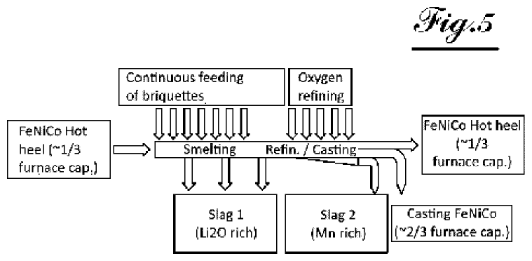

The process is schematized in FIG. 4.

### [FIG. 4] Schematic of the Proposed Pyrometallurgical Process.

The principle of the process and the objectives of each step can be summarized as follows:
1) Agglomeration of the black mass 100 with a binder and addition of a source of iron (see below) (binder, iron ore 110) is intended to obtain a product that is sufficiently resistant to be stored in bulk and charged into a hopper for continuous feeding into the converter via a conveyor. Agglomeration takes place e.g. briquetting E1, then semi-continuous loading 120.
2) Carburizing smelting E2 or reducing-carburizing in a Top Blown Rotary Converter (TBRC) equipped with a lance and/or a gas burner (hydrocarbon or hydrogen)/oxygen and containing the alloy FeNiCoMnC 130 or the alloy FeNiCo from the preceding oxidizing treatment that is re-carburized to FeNiCoC, by using the carbon contained in the black mass, should allow the reducing of the oxides of the reducible metals (Ni, Cu, Co, Fe, Mn), and recovery thereof with a good yield in a carburized metal alloy called FeNiCoMnC; at this step the objective is to separate the Lithium in a slag 140 and in Li-rich dust (in Li2O form) and additionally partly to desulfurize and dephosphorize the metal obtained. The energy to be supplied for the highly endothermal reducing reactions is chiefly provided by combustion of the CO gas derived from the reducing reactions of the oxides, and by combustion of excess Carbon (in the form of C-Fix and hydrocarbons HC), via injection of oxygen; depending on the composition of the black mass, an additional supply of energy may be necessary via a gas burner (hydrocarbon or hydrogen-oxygen), or using a source of electrical energy in the form of an electric arc.
3) Oxidizing refining E3 via injection of oxygen using an oxygen lance 220 and with the addition of lime powder or granules then allows extraction of the alloy FeNiCoMnC, Manganese, Carbon, and a large part of Phosphorus, to obtain first an alloy FeNiCo 150 able to be used in the manufacture of some high alloy steels, and secondly a slag rich in Manganese and lime 160 able to be used in the production of Ferro-Manganese. At this step, the presence of iron in a large proportion provides «protection» for the more valuable metals (Ni and Co). The alloy is cast either by ladle or in ingots 230 on an ingot casting machine—as illustrated in FIG. 4—and the slag is cast by ladle and afterwards optionally granulated or poured into a pit to allow for natural cooling or accelerated cooling by spraying with water.

In practice, the smelting of briquettes of the mixture of black mass+iron ore or source of iron such as scrap iron+Carbon (agglomerated by means of a binder e.g. slaked lime) follows the sequence given below summarized in the simplified process diagram in FIG. 5 below.

### [FIG. 5]: Sequence of Compete Smelting-Refining Process

In a rotary converter the starting material is a «hot metal heel» having ⅓ capacity of the rotary converter and having the analysis of the targeted ferroalloy FeNiCoC; in an operation of continuous production, this hot heel is derived from part of the preceding load that has been re-carburized by adding carbon and agitating the bath by rotation of the converter.

The briquettes of «black mass+iron ore+binder» are fed continuously with short interruptions to pour off excess slag by overflow, until a quantity of metal is obtained corresponding to the nominal capacity of the converter; smelting is conducted continuously with the supply of energy from the «oxygaz» burner and «post-combustion» (combustion of the CO resulting from reducing reactions by injection of additional oxygen).

After complete casting of the furnace slag, refining of the metal can be initiated (extraction of P and Mn) via the continuous injection of oxygen and lime up until the targeted P content is achieved (in general lower than 0.1% P); the remaining metal FeNiCo is then cast but retaining a hot heel of ⅓ the capacity of the reactor, so that the following sequence can be started.

The proportions and compositions of the fed materials, metal baths, and slags obtained are appended hereto.

### 2. EXAMPLE

### 2.1. Composition of the Mix «Black Mass+Fe Ore»

The black mass of the composition given in Table 3 is additioned with standard iron ore of 94% iron oxide Fe2O3, in the proportion of 1 t BM+0.5 t Fe ore. The result is the mix having the composition given in Table 4 below.

TABLE 4
Composition of the black mass + Fe ore mix

| Analysis: Black Mass + Fe ore mix | % | | % | | % |
|---|---|---|---|---|---|
| Ni | 11.3 | Co | 4.7 | S | 0.22 |
| Li | 2.9 | Mn | 6.7 | P | 0.50 |
| Fe | 22.7 | Cu | 0.27 | Ca | 0.01 |
| Al | 0.73 | C fix | 28.0 | HC | 12.0 |

### 2.2. Mass Balances

### 2.2.1. Smelting

The smelting step is conducted in the converter with the mass balance given in Table 5a below.

TABLE 5a
Mass balance of smelting

| | | | 25 | Kg flow/binder | | |
|---|---|---|---|---|---|---|
| 1 t BM incl | 280 kg C fix + + | | 500 | Kg Fe ore | | |
| gives | 451 kg FeNiCoMnC+ | | 151 | Kg slag | yield | |
| << FeNiCoMnC >> | 24.5 | % Ni | 0.5 | % NiO | 0.975 | Ni |
| | 10.0 | % Co | 0.4 | % CoO | 0.970 | Co |
| | 13.0 | % Mn | 5.6 | % MnO | 0.882 | Mn |
| | 48.3 | % Fe | 3.8 | % FeO | 0.960 | Fe |
| | 0.0 | % Si | 29.7 | % CaO | 0.970 | Cu |
| | 0.57 | % Cu | 9.0 | % Al2O3 | 1.00 | Li (s) |
| | 3.5 | % C | 41.7 | % Li2O | | |
| | 0.10 | % S | 1.14 | % S | | |
| | 0.56 | % P | 1.68 | % P | | |

| | | |
|---|---|---|
| 13 kg dust with | 21.9 | % NiO |

| | |
|---|---|
| 9.0 | % CoO |
| 13.1 | % MnO |
| 3.8 | % CaO |

Per 1 t of black mass, smelting yields:
451 kg of FeNiCoMnC alloy, having the composition given in Table 4; an acceptable S content is ascertained (0.1%), but the P content (0.56%) is much too high for use as alloying raw material. The column on the right gives the yields of the metals recovered in the carburized alloy.
150 kg of Li-rich slag (in Li2O form); —with recycling of the dust, a large part of Li is finally recovered in the slag.
13 kg of dust recovered in the gas treatment line via filtration, which is recycled back to the input mixture to be agglomerated.

Alternatively, the smelting step is conducted in the converter with the mass balance given in Table Sb below, which indicates an addition of lime CaO and magnesia MgO, to obtain the following ratios of basicity in the slag resulting from the smelting step: single basicity CaO/SiO2˜1.5, and global basicity (CaO+MgO)/(SiO2+Al2O3) of 0.7 to 0.8.

TABLE 5b
Mass balance of smelting

| | 280 kg C fix + + | | 264 | Nm3 O2 |
|---|---|---|---|---|
| 1 t BM incl | 27 kg CaO/MgO/binder | | 500 | Kg Fe ore |
| gives | 448 kg FeNiCoMnC+ | | 98 | Kg slag |
| << FeNiCoMnC >> | 24.6 | % Ni | 0.7 | % NiO |
| | 10.1 | % Co | 0.6 | % CoO |
| | 13.1 | % Mn | 8.6 | % MnO |
| | 48.1 | % Fe | 8.7 | % FeO |
| | 0.0 | % Si | 20.6 | % CaO |
| | 0.58 | % Cu | 6.8 | % MgO |
| | 3.5 | % C | 20.6 | % Al2O3 |
| | | | 14.2 | % SiO2 |
| | | | 19.2 | % Li2O |
| | 0.1 | % S | 1.58 | % S |
| | 0.68 | % P | 2.04 | % P |

| | | |
|---|---|---|
| 57 kg dust with | 5.1 | % NiO |

| | |
|---|---|
| 2.1 | % CoO |
| 3.0 | % MnO |
| 77.3 | % Li2O |

Per 1 tonne of black mass, smelting yields:
448 kg of FeNiCoMnC alloy, still having the composition indicated in Table 4; the content of S is again found to be acceptable S (0.1%), but the P content (0.63%) is much too high for use as alloying raw material;
119 kg of slag containing part—about ⅓—of the Lithium (in the form of 10-20% of the oxide Li2O);
57 kg of dust recovered in the gas treatment line by filtration, containing about ⅔ of the Lithium in oxide form Li2O, which can extracted e.g. by hydrometallurgy. The remainder which contains valuable metals, especially Ni and Co, will be recycled back into the input mixture to be agglomerated.

The supply of energy for this smelting is provided by combustion of the Carbon (graphite C and hydrocarbons HC), by means of an addition of gaseous oxygen injected via a lance into the metal bath/slag. The amount of injected oxygen is about 260 Nm3/t of black mass (200 to 300 Nm3 per tonne of black mass depending on the exact composition).

### 2.2.2. Refining

The refining step entails extracting the Manganese by injecting oxygen, a metal that is readily oxidizable, at the same time that the Carbon, a large portion of Phosphorus and a portion of Iron are removed. A mass balance of this refining step is given in Table 6a.

At energy level, all these oxidization reactions are largely exothermal and more than cover reactor losses.

TABLE 6a
Mass balance of refining

| | 451 kg FeNiCoMnC + | | 100 | kg CaO + 51 Mm3 | 0.8 | |
|---|---|---|---|---|---|---|
| gives | 312 kg FeNiCo+ | | 257 | O2 kg slag | yield | global |
| << FeNiCo >> | 35.0 | % Ni | 0.5 | % NiO | 0.99 Ni | 0.965 |
| | 14.4 | % Co | 0.2 | % CoO | 0.99 Co | 0.960 |
| | 0.8 | % Mn | 26.9 | % MnO | 0.04 Mn | 0.847 |
| | 48.8 | % Fe | 34.5 | % FeO | 0.7 Fe | 0.672 |
| | 0.8 | % Cu | 37.0 | % CaO | 0.99 Cu | 0.960 |
| | | | 0.0 | % SiO2 | | |
| | 0.1 | % C | 0.0 | % Al2O3 | | |
| | 0.069 | % S | 0.1 | % S | | |
| | 0.081 | % P | 0.8 | % P | | |

| | | |
|---|---|---|
| 14 kg dust with | 0.5 | % NiO |

| | |
|---|---|
| 0.2 | % CoO |
| 26.9 | % MnO |
| 34.5 | % FeO |
| 37.0 | % CaO |

Per 1 t of black mass, refining therefore gives:
312 kg of FeNiCo alloy having the composition indicated in Table 5; acceptable contents of S (0.069%) and of P (0.081%) are found. The right-side column gives the yields of metals recovered in the FeNiCo alloy—by distinguishing between the yield at refining and the global yield of the element starting from the black mass;
257 kg of slag with high content of Mn, Fe and lime;
14 kg of dust having a composition close to that of the slag, in which it can be incorporated before casting.

Alternatively, a mass balance of this refining step is given in Table 6b.

Per 1 tonne of black mass, refining gives:
311 kg of FeNiCo alloy having the composition indicated in Table 5; again acceptable contents are found of S (0.083%) and P (0.091%);
262 kg of slag with high content of Mn, Fe and lime;
8 kg of dust having a composition close to that of the slag to which it can be added before casting.

TABLE 6b
Mass balance of refining

| | 448 kg FeNiCoMnC + | | 100 | kg CaO + 51 Nm3 |
|---|---|---|---|---|
| gives | 311 kg FeNiCo+ | | 262 | O2 kg slag |
| << FeNiCo >> | 35.2 | % Ni | 0.5 | % NiO |
| | 14.4 | % Co | 0.2 | % CoO |
| | 0.8 | % Mn | 27.0 | % MnO |
| | 48.5 | % Fe | 34.2 | % FeO |
| | 0.8 | % Cu | 37.0 | % CaO |
| | | | 0.0 | % SiO2 |
| | 0.1 | % C | 0.0 | % Al2O3 |
| | 0.083 | % S | 0.1 | % S |
| | 0.091 | % P | 0.9 | % P |

| | | |
|---|---|---|
| 8 kg dust with | 0.5 | % NiO |

| | |
|---|---|
| 0.2 | % CoO |
| 27.0 | % MnO |
| 34.2 | % FeO |
| 37.0 | % CaO |

### 2.3. Upcycling Applications

The 3 products obtained have ensured reuse, of which the applications can be specified as follows:
the FeNiCo alloy having 48 or 49% Fe, 35% Ni, 14% Co can advantageously be used to produce high alloy steels of Maraging type, used in aeronautics, and which typically contain 17˜19% Ni, 8˜12% Co. It could therefore replace supplies of Ni and Co raw materials in the form of ferroalloys;
the slag and dust high in Li2O form a very rich Li ore that can readily be incorporated in the Li extraction and production industry via hydrometallurgical route;
the slag FeO—MnO—CaO containing ˜27% MnO (˜21% Mn) will form a raw material of choice for carbothermal reducing furnaces producing ferromanganese. In these furnaces, routine use is made of 40% Mn ore, but large quantities of lime CaO are added thereto since high basicity of the slag promotes the yield of Manganese. The slag FeO—MnO—CaO resulting from recovery of the black mass will therefore replace a Manganese ore, an addition of lime CaO and an addition of Iron, all at the same time.

### 2.4. The Case of Low-Phosphorus Black Mass

A black mass free of Phosphorus or with low Phosphorus content is of close typical composition, an example of which is given in Table 7 below.

Here the content of Phosphorus is 10 times less than in the standard black mass.

TABLE 7
Typical composition of low-Phosphorus black mass.

| Analysis: Low P Black Mass | % | | % | | % |
|---|---|---|---|---|---|
| Ni | 17.0 | Co | 7.0 | S | 0.20 |
| Li | 4.4 | Mn | 10.0 | P | 0.05 |
| Fe | 1.0 | Cu | 0.40 | Ca | 0.02 |
| Al | 0.80 | C fix | 28.0 | HC | 12.0 |

One application of reuse is evidently the one described for high Phosphorus content, comprising 2 steps (smelting and refining) ultimately leading to a low-Phosphorus FeNiCo alloy that can be used in the preparation of high alloy steels with high contents of Ni and Co.

The mass balances of this industry are grouped together in Tables 8a and 8b below.

TABLE 8a
Smelting and refining mass balances for low-Phosphorus black mass.

Smelting mass balance

| | | 25 | kg flow/binder |
|---|---|---|---|
| 1 t BM incl | 280 kg C fix + + | 500 | kg Fe ore |

| | | | | |
|---|---|---|---|---|
| gives | 451 kg FeNiCoMnC+ | 151 | kg slag | yield |

| | | | | | | |
|---|---|---|---|---|---|---|
| << FeNiCoMnC >> | 24.5 | % Ni | 0.5 | % NiO | 0.975 | Ni |
| | 10.0 | % Co | 0.4 | % CoO | 0.970 | Co |
| | 13.0 | % Mn | 5.6 | % MnO | 0.882 | Mn |
| | 48.3 | % Fe | 3.8 | % FeO | 0.960 | Fe |
| | 0.0 | % Si | 29.7 | % CaO | 0.970 | Cu |
| | 0.57 | % Cu | 9.0 | % Al2O3 | 1.00 | Li (s) |
| | 3.5 | % C | 41.7 | % Li2O | | |
| | 0.10 | % S | 1.14 | % S | | |
| | 0.56 | % P | 0.17 | % P | | |

| | | |
|---|---|---|
| 13 kg dust with | 21.9 | % NiO |

| | |
|---|---|
| 9.0 | % CoO |
| 13.1 | % MnO |
| 3.8 | % CaO |

| Refining mass balance | | | | | | |
|---|---|---|---|---|---|---|
| | 451 kg FeNiCoMnC + | | 100 | kg CaO + 49 Mm3 | 0.8 | |
| gives | 312 kg FeNiCo+ | | 255 | O2 kg slag | yield | global |
| << FeNiCo >> | 35.1 | % Ni | 0.5 | % NiO | 0.99 Ni | 0.965 |
| | 14.4 | % Co | 0.2 | % CoO | 0.99 Co | 0.960 |
| | 0.8 | % Mn | 27.1 | % MnO | 0.04 Mn | 0.847 |
| | 48.8 | % Fe | 34.7 | % FeO | 0.7 Fe | 0.672 |
| | 0.8 | % Cu | 37.2 | % CaO | 0.99 Cu | 0.960 |
| | | | 0.0 | % SiO2 | | |
| | 0.1 | % C | 0.0 | % Al2O3 | | |
| | 0.069 | % S | 0.1 | % S | | |
| | 0.008 | % P | 0.1 | % P | | |

| | | |
|---|---|---|
| 13 kg dust with | 0.5 | % NiO |

| | |
|---|---|
| 0.2 | % CoO |
| 27.1 | % MnO |
| 34.7 | % FeO |
| 37.2 | % CaO |

TABLE 8b
Smelting and refining mass balances
for low-Phosphorus black mass.

| 1 t BM incl + | 280 kg Cfix +/ | | 264 | Nm3 O2 |
|---|---|---|---|---|
| 27 kg flow/ | MgO/ + | | 500 | kg Fe ore |
| CaO gives | 439 kg Fe NiCoMnC+ | | 97 | kg slag |
| << FeNiCoMnC >> | 24.6 | % Ni | 0.7 | % NiO |
| | 10.1 | % Co | 0.6 | % CoO |
| | 13.1 | % Mn | 8.5 | % MnO |
| | 48.1 | % Fe | 8.6 | % FeO |
| | 0.0 | % Si | 20.8 | % CaO |
| | 0.58 | % Cu | 6.9 | % MgO |
| | 3.5 | % C | 20.5 | % Al2O3 |
| | | | 14.1 | % SiO2 |
| | | | 19.3 | % Li2O |
| | 0.13 | % S | 1.6 | % S |
| | 0.07 | % P | 0.21 | % P |

| | | |
|---|---|---|
| 70 kg dust with | 8.3 | % NiO |

| | |
|---|---|
| 3.4 | % CoO |
| 4.9 | % MnO |
| 63.0 | % Li2O |

However, it appears that the main poisonous element for the recycling of highly valuable metals (Ni and Co), namely Phosphorus, is in this case already quite largely removed at the smelting step at which it is lowered to less than 0.1% P in the FeNiCoMnC ferroalloy.

It is true that the standard analysis of FeNiCo alloys of «Maraging» type comprises low Mn and C contents (often less than 0.2% each). Nonetheless there are possibilities of direct use of the FeNiCoMnC alloys, either by including these at a preliminary production phase (at which Mn and C are removed) or for derivative versions of these types of ferroalloy tolerating higher contents of Mn and C.

### 3. SUMMARY

Batteries of Li-ion type, as valuable elements it is crucial to properly recycle, comprise Copper Cu, Aluminium Al (2 metals contained in metallic form), Nickel Ni, Cobalt Co, Manganese Mn and evidently Lithium—the latter in the form of combined oxides.

In known recovery channels, the recycling of these batteries—whether concerning production waste, spent batteries or faulty new batteries—includes a size reduction step using a shredder which in good proportions separates Copper and Aluminium (metals), and produces a «black mass» grouping together the other metals as well as a high proportion of carbon in elementary (C-Fix) or combined form, in plastics and oils similar to hydrocarbons.

Several solutions are currently proposed and are being tested to upgrade this black mass, most often via hydrometallurgical route—and in several steps.

In this document there is proposed a 3-step pyrometallurgical solution:
Agglomeration of the black mass (pelleting, briquetting or extrusion)—with the addition of iron ore and a suitable binder.
Carburizing-reducing smelting in a rotary converter (or other type of converter equipped with an agitation device) allowing the Lithium to be separated in a slag and dust with high Li2O content, which are highly upgradable in industries currently producing this metal. Additions of lime and magnesia to the mixture, before carburizing smelting, allow the obtaining of a first fluid slag after overflow having basicity indexes of: single basicity b=CaO/SiO2 of about 1.5, and global basicity B=(CaO+MgO)/(SiO2+Al2O3) of about 0.7˜0.8. This first slag contains lithium.

The main supply of energy for carburizing smelting is generally combustion of the Carbon in the black mass via injection of gaseous oxygen into the bath.
Oxidizing refining in the same converter, or in a second specific converter, leads to an alloy of FeNiCo type containing about 50% (Ni+Co), which can be used for the preparation of high-strength steels (in particular steels used in aeronautics), and to a slag high in Manganese, in Iron and lime which forms an excellent raw material for furnaces producing Ferro-Manganese.

1. A process for recovering black mass (100) derived from lithium batteries, characterized in that the process comprises an addition (E1) of an iron source (110) to the black mass to obtain a mixture, carburizing smelting (E2) of the mixture by supply of energy to obtain a carburized metal bath (130), separating a first slag (140), followed by oxidizing treatment (E3) of the carburized metal bath thus refined, and separation of a second slag (160) to obtain a ferroalloy (150).

2. The process for recovering black mass according to claim 1, characterized in that the carbon is chiefly provided by the graphite contained in the black mass and, if a supplement is needed, in the form of anthracite or substitution carbon material, for the purpose of smelting the mixture.

3. The process for recovering black mass according to claim 1, characterized in that agglomeration into pellets or briquettes, or extrusion is carried out before smelting.

4. The black mass recovery process according to claim 1, characterized in that smelting is conducted in a rotary converter (200) or converter equipped with an agitation device.

5. The black mass recovery process according to claim 1, characterized in that an addition of iron ore as iron source at about 94% iron oxide Fe2O3 to the battery black mass to obtain the mixture, is made in the proportion of ½ iron ore quantity per 1 quantity of battery black mass.

6. The black mass recovery process according to claim 1, characterized in that the black mass is derived from shredded or dissembled lithium batteries.

7. The black mass recovery process according to claim 1, characterized in that slaked lime is added as binder to facilitate at least agglomeration of the black mass and iron ore as source of iron.

8. The black mass recovery process according to claim 1, characterized in that quicklime is added during the oxidizing treatment.

9. The black mass recovery process according to claim 1, characterized in that an operation of continuous production is carried out during which an addition of carbon is made to one fraction of the metal bath resulting from oxidizing treatment after separation of the second slag, this fraction being used to receive a new feed of black mass and iron source to form the mixture that is the subject of smelting to obtain the carburized metal bath.

10. The black mass recovery process according to claim 1, characterized in that the iron source is iron ore.

11. The black mass recovery process according to claim 1, characterized in that the iron source is oxidized or non-oxidized scrap iron.

12. The black mass recovery process according to claim 1, characterized in that additions of lime and magnesia to the mixture before carburizing smelting allow the obtaining of a first slag (140) having basicity indexes of: single basicity b=CaO/SiO2, of about 1.5, and global basicity B=(CaO+MgO)/(SiO2+Al2O3) of about 0.7˜0.8.
